(19) United States
(12) Patent Application Publication
(10) Pub. No.: US 2026/0030008 A1
(43) Pub. Date: Jan. 29, 2026

(54) METHOD FOR CONFIGURING SERVICE PACKAGE AND APPARATUS

(71) Applicant: BOE Technology Group Co., Ltd., Beijing (CN)

(72) Inventor: Weiling LIU, Beijing (CN)

(73) Assignee: BOE Technology Group Co., Ltd., Beijing (CN)

(21) Appl. No.: 18/997,834

(22) PCT Filed: Aug. 17, 2023
(86) PCT No.: PCT/CN2023/113511

§ 371 Date: Jan. 23, 2025

(30) Foreign Application Priority Data
Aug. 19, 2022 (CN) 202210999883.6

(51) Int. Cl. G06F 8/60; G06F 8/38; G06F 8/71

(52) U.S. Cl. CPC G06F 8/60; G06F 8/38; G06F 8/71

(57) ABSTRACT

A method for configuring a service package, includes: obtaining configuration information of configuration items of a target service package; generating a detail page of the target service package according to the configuration information of the configuration items of the target service package, and determining an access address of the detail page of the target service package; and sending information for instructing the target service package to be launched to a target mini program associated with the target service package, the information for instructing the target service package to be launched includes the access address of the detail page of the target service package.

### CROSS-REFERENCE TO RELATED APPLICATIONS

This application is a national phase entry under 35 USC 371 of International Patent Application No. PCT/CN2023/113511, filed on Aug. 17, 2023, which claims priority to Chinese Patent Application No. 202210999883.6, filed on Aug. 19, 2022, which are incorporated herein by reference in their entirety.

### TECHNICAL FIELD

The present disclosure relates to the field of medical information technologies, and in particular, to a method for configuring a service package and an apparatus.

### BACKGROUND

With the continuous development of computer technologies, various applications have entered people's daily lives, and mini programs, as applications that can be used without downloading and installing, have attracted widespread attention from all walks of life.

At present, service packages for mini programs are developed manually by developers in the form of code. The development cycle of a service package for a mini program is long and the workload of developers is heavy.

### SUMMARY

In an aspect, a method for configuring a service package is provided. The method includes: obtaining configuration information of configuration items of a target service package; generating a detail page of the target service package according to the configuration information of the configuration items of the target service package, and determining an access address of the detail page of the target service package; and sending information for instructing the target service package to be launched to a target mini program associated with the target service package, the information for instructing the target service package to be launched includes the access address of the detail page of the target service package.

In some embodiments, obtaining the configuration information of the configuration items of the target service package, includes: displaying a service package configuration interface in response to an operation instruction to open the service package configuration interface, the service package configuration interface including input boxes for the configuration items of the target service package; and obtaining the configuration information of the configuration items of the target service package in response to a user's input operation on the input boxes for the configuration items of the target service package on the service package configuration interface.

In some other embodiments, the method further includes: detecting, for each configuration item of the target service package, whether configuration information of the configuration item complies with configuration rules of the configuration item; and displaying a prompt message on the service package configuration interface in a case where the configuration information of the configuration item does not comply with the configuration rules of the configuration item, to instruct a user to re-input configuration information for the configuration item.

In some other embodiments, the configuration rules of the configuration item include determining whether an input box of the configuration item is empty.

In some other embodiments, a configuration item is a service package name, and configuration rules of the service package name includes determining whether the service package name obtained this time has already existed, determining whether a number of words of the service package name obtained this time is greater than or equal to a preset number of words, and determining whether there is a space or an unknown character in the service package name obtained this time. Or a configuration item is a picture, and configuration rules of the picture includes determining whether a size of the picture meets a preset size and whether a resolution of the picture meets a preset resolution.

In some other embodiments, the method further includes: obtaining updated configuration information of a first configuration item of the target service package; and regenerating a detail page of the target service package according to the updated configuration information of the first configuration item and configuration information of a second configuration item. The second configuration item is a configuration item other than the first configuration item in the configuration items of the target service package, and an access address of the detail page of the target service package after regeneration is same as the access address of the detail page of the target service package before regeneration.

In some other embodiments, the method further includes: sending information for instructing the target service package to be withdrew to the target mini program in a case where a preset withdrawing condition is met. The preset withdrawing condition includes any of the following: a launch duration of the target service package reaching a preset duration; an inventory number of target service packages being less than or equal to a preset number; and receiving an operation instruction for instructing the target service package to be withdrew from a user.

In some other embodiments, the detail page of the target service package is a fifth-generation hypertext markup language (H5) page.

In some other embodiments, the detail page of the target service package displays introduction information of the target service package.

In some other embodiments, in a case where the target service package is a medical service package, the configuration items of the target service package include one or more of the following: service package name, medical expert team information, service package price, service item, service package picture, number of benefits, promotion, service package validity period or service package inventory information.

In another aspect, a management server is provided. The management server includes a memory and a processor. The memory is coupled to the processor, and used for storing computer program codes, the computer program codes including computer instructions. The computer instructions, when executed by the processer, cause the processer to perform the method for configuring the service package as described in any one of the above embodiments.

In some embodiments, the management server further includes a communication interface used for connecting the management server to other devices through a communication network.

In some embodiments, the management server further includes an output device and an input device. The output device communicates with the processor and is used for display information. The input device communicates with the processor and is used for receiving user input.

In some embodiments, the memory stores preset corresponding relationships between a plurality of service packages and a plurality of mini programs in advance; one mini program has corresponding relationships with service packages. After the processor generates the detail page of the target service package and determines the access address of the detail page of the target service package, the processor determines the target mini program corresponding to the target service package according to the preset corresponding relationships.

In yet another aspect, a non-transitory computer-readable storage medium is provided. The computer-readable storage medium has stored computer program instructions that, when run on a processer, cause the processer to perform one or more steps of the method for configuring the service package as described in any one of the above embodiments.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely accompanying drawings of some embodiments of the present disclosure, and a person of ordinary skill in the art can obtain other drawings according to these drawings. In addition, the accompanying drawings to be described below may be regarded as schematic diagrams, and are not limitations on actual sizes of products, actual processes of methods and actual timings of signals involved in the embodiments of the present disclosure.

FIG. 1 is a composition diagram of a service package management system, in accordance with some embodiments;

FIG. 2 is a hardware structure diagram of a management server, in accordance with some embodiments;

FIG. 3 is a flowchart of a method for configuring a service package, in accordance with some embodiments;

FIG. 4 is another flowchart of a method for configuring a service package, in accordance with some embodiments;

FIG. 5 is an interface diagram of a mall system, in accordance with some embodiments;

FIG. 6 is another interface diagram of a mall system, in accordance with some embodiments;

FIG. 7 is yet another interface diagram of a mall system, in accordance with some embodiments;

FIG. 8 is an interface diagram of a target mini program, in accordance with some embodiments;

FIG. 9 is yet another flowchart of a method for configuring a service package, in accordance with some embodiments;

FIG. 10 is yet another flowchart of a method for configuring a service package, in accordance with some embodiments;

FIG. 11 is yet another interface diagram of a mall system, in accordance with some embodiments;

FIG. 12 is yet another flowchart of a method for configuring a service package, in accordance with some embodiments;

FIG. 13 is yet another interface diagram of a mall system, in accordance with some embodiments;

FIG. 14 is yet another interface diagram of a mall system, in accordance with some embodiments;

FIG. 15 is yet another flowchart of a method for configuring a service package, in accordance with some embodiments;

FIG. 16 is an interface diagram of an application program, in accordance with some embodiments;

FIG. 17 is another interface diagram of a target mini program, in accordance with some embodiments;

FIG. 18 is yet another interface diagram of a target mini program, in accordance with some embodiments;

FIG. 19 is yet another interface diagram of a target mini program, in accordance with some embodiments;

FIG. 20 is yet another interface diagram of a target mini program, in accordance with some embodiments;

FIG. 21 is yet another interface diagram of a target mini program, in accordance with some embodiments;

FIG. 22 is yet another interface diagram of a target mini program, in accordance with some embodiments;

FIG. 23 is yet another interface diagram of a target mini program, in accordance with some embodiments; and

FIG. 24 is a structural diagram of a service package management apparatus, in accordance with some embodiments.

### DETAILED DESCRIPTION

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a/the plurality of” means two or more unless otherwise specified.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term “if”, depending on the context, is optionally construed as “when”, “in a case where”, “in response to determining”, or “in response to detecting”. Similarly, depending on the context, the phrase “if it is determined” or “if [a stated condition or event] is detected” is optionally construed as “in a case where it is determined”, “in response to determining”, “in a case where [the stated condition or event] is detected”, or “in response to detecting [the stated condition or event]”.

The phrase “applicable to” or “configured to” as used herein indicates an open and inclusive expression, which does not exclude devices that are applicable to or configured to perform additional tasks or steps.

In addition, the phrase “based on” as used herein is meant to be open and inclusive, since a process, step, calculation or other action that is “based on” one or more of the stated conditions or values may, in practice, be based on additional conditions or values beyond those stated.

As an application that can be used without downloading and installing, the mini program realizes a dream, that is, the application is “within reach”. Users can open the application by scanning or searching. An idea of “leaving after using” is also embodied, and the user does not need to worry about insufficient memory on the user terminal due to installation of too many applications. Mini programs make applications ubiquitous and available at any time, without being installed or uninstalled.

At present, service packages for mini programs are developed manually by developers in the form of code. The development cycle is long and the workload of developers is heavy. Since the service package is developed in the form of code, the service package has the risk of bugs and requires the tester to test, resulting in high development costs for the service package of the mini program. After the service package for the mini program is developed and launched, if a certain function of the launched service package needs to be modified, the developer still needs to modify the function of the service package in the form of code, resulting in poor flexibility of modifying the service package, and further increasing the workload of the developer. Therefore, how to shorten the development cycle of a service package for a mini program and reduce the workload of developers is an issue that needs to be solved urgently.

In light of this, embodiments of the present disclosure provide a method for configuring a service package. The method obtains configuration information of configuration item(s) of a target service package input by a user, and then generates a detail page of the target service package according to the configuration information of the configuration item(s) of the target service package, thereby completing the development of the target service package. While generating the detail page of the target service package, the method determines an access address of the detail page of the target service package, and then send information for instructing the target service package to be launched to a target mini program associated with the target service package, thereby completing the launch of the target service package. It can be seen that, in the method for configuring the service package provided in the embodiments of the present disclosure, it only requires the user to input the configuration information of the configuration item(s) of the target service package, thereby completing the development and launch of the target service package, without manual development based on code by developers. Thus, the development efficiency of the service package of the mini program is improved, the development cycle of the service package of the mini program is shortened, and the workload of developers is reduced.

The method for configuring the service package provided in the embodiments of the present disclosure can be applied to the development process of the service package, the modification process of the service package, the launching and withdrawing processes of the service package, and other processes.

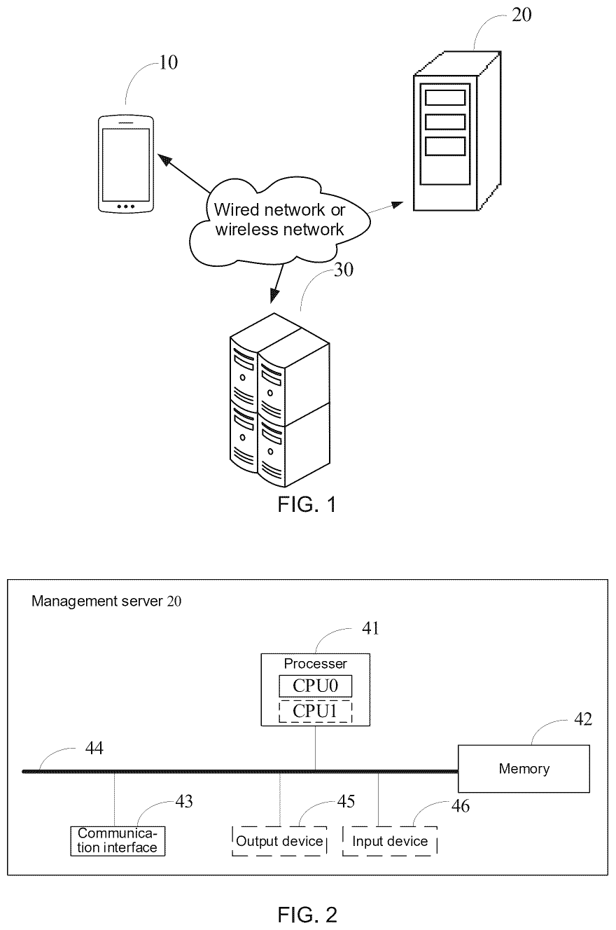

As shown in FIG. 1, embodiments of the present disclosure provide a service package management system. The service package management system includes a terminal device 10, a management server 20 and a payment server 30. The terminal device 10, the management server 20 and the payment server 30 may be connected through a wired network or a wireless network. The wired network or wireless network may include routers, switches, base stations, or other devices that facilitate communication between the terminal device 10, the management server 20, and the payment server 30, which are not limited in the embodiments of the disclosure.

In some embodiments, an instant messaging application is installed and run in the terminal device 10. The instant messaging application includes a mini program, and the mini program relies on the instant messaging application (host program) to run. For example, the mini program is a medical mini program.

In some embodiments, the management server 20 is used to host the mall system. The mall system has various functions for managing the service package.

For example, the mall system has a function of configuring the configuration information of the configuration item(s) of the service package. The user may configure each configuration item of the service package associated with the mini program in the application through the mall system, and then the management server 20 may generate the detail page of the service package according to the configuration information of the configuration item(s), thereby completing the development of the service package.

For example, the mall system has a function of modifying the configuration information of the configuration item(s) of the service package. The user may modify the configuration information of a certain configuration item of the configured service package through the mall system, and then the management server 20 may regenerate the detail page of the service package according to the modified configuration information of the certain configuration item and the configuration information of other unmodified configuration items.

For example, the mall system has a function of deleting the service package. The user may delete configured service package through the mall system.

For example, the mall system has functions of launching and withdrawing the service package. The user may control the service package to be launched and withdrew in the mini program through the mall system.

For example, the mall system has a function of configuring and publishing promotional information. The User may configure a variety of promotional information through the mall system. Each piece of promotional information may include coupons or gift cards of different amounts, and different pieces of promotional information may correspond to different service packages. After the promotional information is configured, the user uploads the promotional information to the corresponding mini program through the mall system.

In some embodiments, the payment server 30 is a server that can handle transactions such as subscription and charge deduction. The payment server 30 may communicate with the financial system. For example, the payment server 30 may be a server of “Zhuojian” payment system.

In some embodiments, the terminal device 10 is a device with a wireless transceiving function. The terminal device 10 may have different names, such as a user equipment (UE), access terminal, terminal unit, terminal station, mobile station, mobile platform, remote station, remote terminal, mobile device, wireless communication device, terminal agent or terminal apparatus. The terminal may be deployed on land, which includes indoor or outdoor, handheld, or vehicle-mounted; the terminal may also be deployed on water (e.g., on a ship); the terminal may also be deployed in the air (e.g., on an airplane, on a balloon, on a satellite). The terminal may be a cellular phone, a cordless phone, a session initiation protocol (SIP) phone, a wireless local loop (WLL) station, a personal digital assistant (PDA), a handheld device with the wireless communication function, a computing device or any other processing device connected to a wireless modem, a vehicle-mounted device or wearable device, an unmanned aerial vehicle (UAV) or UAV controller (UAVC), a virtual reality (VR) terminal device, an augmented reality (AR) terminal device, a wireless terminal in industrial control, a wireless terminal in unmanned driving, a wireless terminal in remote medical, a wireless terminal in smart grid, a wireless terminal in transportation safety, a wireless terminal in smart city, or a wireless terminal in smart home. The terminal device 10 may be mobile or fixed. In the embodiments of the present disclosure, the apparatus used to implement the function of the terminal device may be a terminal, or may be an apparatus that can support the terminal to implement the function, such as a chip system. In the embodiments of the present disclosure, the chip system may be composed of chips, or may include chips and other discrete devices. In the embodiments of the present disclosure, the technical solution provided in the embodiments of the present disclosure is described by taking an example where the apparatus for implementing the function of the terminal device is a terminal.

In some embodiments, the management server 20 and the payment server 30 may be independent physical servers, or may be server clusters composed of multiple physical servers or distributed systems, or may be cloud services that provide basic cloud computing servers, such as cloud services, cloud databases, cloud computing, cloud functions, cloud storage, network services, cloud communication, middleware services, domain name services, security services, content delivery networks (CDN), and big data and artificial intelligence platforms. Optionally, the management server 20 is a server including a display screen, and relevant interfaces of the mall system can be displayed on the display screen.

It should be noted that the method for configuring the service package provided in the embodiments of the present disclosure may be applied to the management server 20 or other device(s) connected to the management server 20. For the convenience of description, the following is described by taking an example where the method is applied to the management server 20.

FIG. 2 is a hardware structure diagram of a management server 20, in accordance with embodiments of the present disclosure. As shown in FIG. 2, the management server 20 may include a processor 41, a memory 42, a communication interface 43 and a bus 44. The processor 41, the memory 42 and the communication interface 43 may be connected through the bus 44.

The processor 41 is a control center of the management server 20. The processor 41 may be a single processor, or may be a general term of a plurality of processing components. For example, the processor 41 may be a general-purpose CPU or other general-purpose processor. The general-purpose processor may be a micro-processor, or any conventional processor.

As an embodiment, the processor 41 includes one or more CPUs, for example, CPU0 and CPU1 shown in FIG. 2.

The memory 42 may be, but is not limited to, a read-only memory (ROM) or a static storage device of any other type that can store static information and instructions, a random access memory (RAM) or a dynamic storage device of any other type that can store information and instructions, an electrically erasable programmable read-only memory (EEPROM), a magnetic disk storage medium or any other magnetic storage device, or any other medium that can be used to carry or store desired program codes in a form of instructions or data structures and that can be accessed by a computer.

In a possible implementation, the memory 42 can exist independently of the processor 41, and the memory 42 may be connected to the processor 41 through the bus 44 for storing instructions or program codes. When calling and executing the instructions or program codes stored in the memory 42, the processor 41 can implement the method for configuring the service package provided in the following embodiments of the present disclosure.

In another possible implementation, the memory 42 can also be integrated with the processor 41.

The communication interface 43 is used to connect the management server 20 to other devices through a communication network. The communication network may be Ethernet, radio access network (RAN), or wireless local area networks (WLAN), etc. The communication interface 43 may include a receiving unit for receiving data, and a transmitting unit for transmitting data.

The bus 44 may be an industry standard architecture (ISA) bus, a peripheral component interconnect (PCI) bus or an extended industry standard architecture (EISA) bus, etc. The bus may be divided into address bus, data bus, control bus, etc. For ease of presentation, only one thick line is used in FIG. 2, but it does not mean that there is only one bus or one type of bus.

In some embodiments, the management server 20 further includes an output device 45 and an input device 46. The output device 45 communicates with the processor 41 and can display information in a variety of ways. For example, the output device 45 is a liquid crystal display (LCD), a light-emitting diode (LED) display device, a cathode ray tube (CRT) display device, or a projector. The input device 46 communicates with the processor 41 and can receive user input in a variety of ways. For example, the input device 46 is a mouse, keyboard, touch screen device, or sensing device.

It should be noted that, the components shown in FIG. 2 do not limit the management server 20. In addition to the components shown in FIG. 2, the management server 20 may include more or less components than those shown in the figure, or combinations of certain components, or different component arrangements.

Embodiments provided in the present disclosure will be described below in combination with the accompanying drawings.

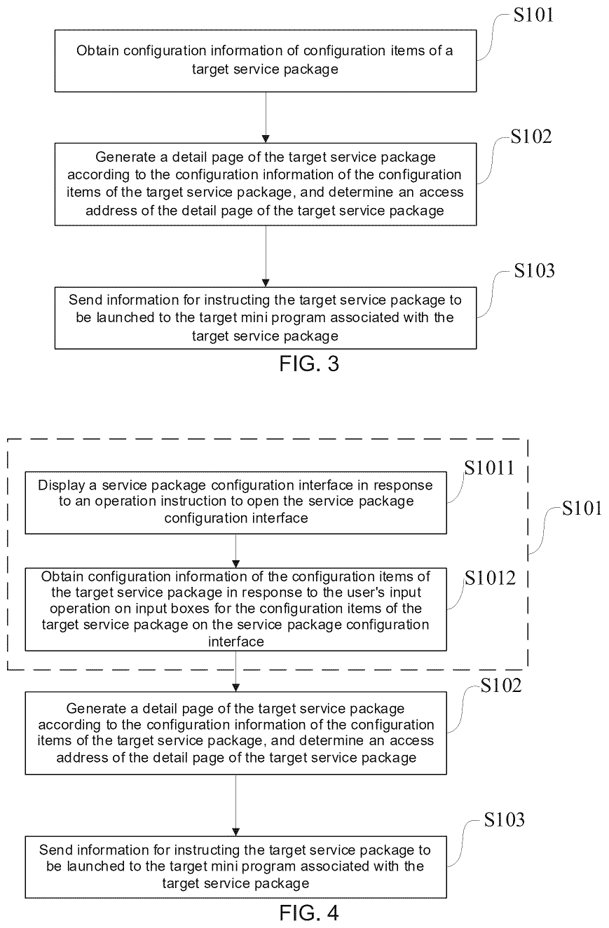

Embodiments of the present disclosure provide a method for configuring a service package, and the method may be applied to a management server. The management server may be the management server 20 shown in FIG. 2, or the processor of the management server 20. As shown in FIG. 3, the method includes the following steps.

In S101, configuration information of configuration items of a target service package is obtained.

In some embodiments, when the user needs to launch the target service pack, the management server can obtain the configuration information of the configuration items of the target service package.

For example, the target service package may be a service package such as a medical service package or a takeaway service package. For ease of description, the following embodiments are described by taking the target service package as a medical service package.

It should be understood that, with the emergence of “Internet plus medical health” in the field of medical services, patients may purchase corresponding medical service packages through a medical mini program according to their own physical conditions, for various services such as graphic-text consultation, video consultation, and appointment face-to-face visit, and diverse needs may be met through the medical mini program for patients without going to the hospital.

In some embodiments, in the case where the target service package is the medical service package, the configuration items of the target service package include one or more of the following: service package name, service package type, medical expert team information, service package price, service item, service package picture, number of benefits, promotion, service package validity period or service package inventory information.

The service package inventory information is the stock keeping unit (SKU). SKU is a basic unit for inventory measurement, which can be in units of pieces, boxes, etc. In the embodiments of the present disclosure, SKU refers to the number of times the target service package can be purchased. It can be understood that, the number of available consultations for the medical expert team within a time period (such as a week) is limited, so that the number of times the target service package can be purchased within the time period is also limited.

In some examples, as shown in FIG. 4, the step 101 may be implemented through the following steps.

In S1011, a service package configuration interface is displayed in response to an operation instruction to open the service package configuration interface.

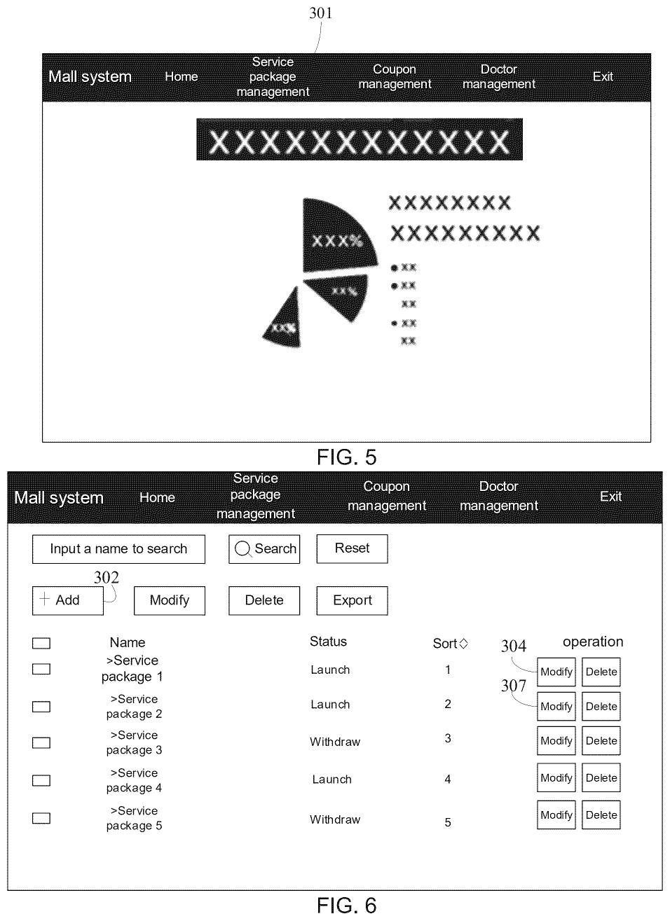

In some embodiments, when the user needs to use the mall system, the user can log in to the mall system through the management server. FIG. 5 is an interface diagram of the mall system, in accordance with embodiments. As shown in FIG. 5, the interface of the mall system displays icons of function buttons such as Home, Service package management, Coupon management, Doctor management, Exit.

In some embodiments, when the user needs to manage the service package, the user can operate the function button of the service package management 30. After detecting the user's operation on the function button of “Service package management” 301, the management server displays the service package management interface in response to the user's operation on “Service package management” 301.

It should be noted that, “operations” involved in the embodiments of the present disclosure all refer to operations performed by the user. For example, the operation may be a single-click, double-click, or drag by using a mouse, or it may also be in a form of touching screen, gesture, voice, or the like.

For example, the service package management interface is as shown in FIG. 6. The service package management interface displays icons for more than 20 function buttons such as input box of search column, search, reset, add, and modify. The service package management interface further displays status and serial number of the configured service package. For example, Service package 1 is in a launched status and has the serial number of 1; Service package 2 is in a launched status and has the serial number of 2. After each configured service package, icons of the modification function button for modifying the service package and the deletion function button for deleting the service package may also be displayed.

In some embodiments, when the user needs to configure a target service package, the user may operate the function button of “Add” 302 to open the service package configuration interface.

After detecting the user's operation instruction to open the service package configuration interface for the function button of “Add” 302, the management server displays the service package configuration interface in response to the operation instruction to open the service package configuration interface.

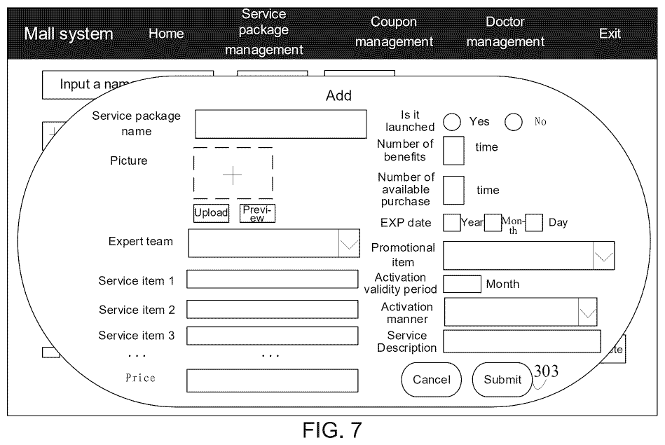

For example, the service package configuration interface is as shown in FIG. 7. The service package configuration interface includes input boxes for configuration items of the target service package. For example, the service package configuration interface displays an input box for service package name, upload button icon and preview button icon for picture(s), selection box for expert team, input boxes for service items included in the service package (e.g., an input box for Service item 1, an input box for Service item 2, and so on), as well as input box for price, selection box for “is it launched”, input box for the number of benefits, an input box for the number of available purchase, input box for the expiration date (EXP date), selection box for the promotional item, input box for the activation validity period, selection box for the activation manner, and input box for the service description.

In some embodiments, the selection box for the expert team is used for the user to configure the expert team for the target service package. Regarding the configuration of the expert team, the user can enter a doctor management interface through the doctor management button displayed on the mall system interface. On the doctor management interface, the user can configure the picture of each expert team, the brief introduction of each expert team, the picture of each of a plurality of doctors included in each expert team, the field(s) in which each doctor is expert, and the services that each doctor can provide (such as graphic-text consultation, video consultation, telephone consultation), the price of each service provided by each doctor, the services that each expert team can provide, and the price of each service provided by each expert team.

In some embodiments, the input box for the number of benefits is used for the user to configure the number of times that the target service package provides services to the patient, for example, 5 times, which represents 5 medical services that are provided by the expert team of the target service package after the patient purchases the target service package.

In some embodiments, the selection box for the promotional item is used for the user to configure the promotional information of the target service package, for example, for the user to configure the first order discount, full discount, etc. of the target service package. Regarding the configuration of the promotional item, the user can enter a coupon management interface through the coupon management button displayed on the mall system interface. On the coupon management interface, the user can configure coupons of different denominations, as well as the usage period of each denomination, usage conditions of each denomination (for example, coupons of different denominations can be used when different amounts are met), and activation manners of each denomination (including key activation, serial code (CDKEY, CDK) activation, etc.). The selection box for the activation manner is used for the user to configure the activation manner of the target service package. The activation manner includes key activation, CDK activation.

In S1012, the configuration information of the configuration items of the target service package is obtained in response to the user's input operation on the input boxes for the configuration items of the target service package on the service package configuration interface.

In some embodiments, the user can perform input operations on the input boxes for the configuration items of the target service package on the service package configuration interface according to the text reminders of the configuration items, so as to configure the configuration items of the target service package. After receiving the user's input operations on the configuration items, the management server obtains the configuration information of the configuration items of the target service package in response to the user's input operations on the input boxes for the configuration items of the target service package on the service package configuration interface. That is, the management server obtains the configuration information of the configuration items during the user's input process into the input boxes for the configuration items.

As a possible implementation, as shown in FIG. 7, after the user completes input into the input boxes of the configuration items of the target service package, the user can click the icon of the function button of “Submit” 303 to submit the configuration information of the configuration items of the target service package. After receiving the operation of the user clicking the icon of the function button of “Submit” 303, the management server obtains the configuration information of the configuration items of the target service package in response to the operation of the user clicking the icon of the function button of “Submit” 303. That is, the management server obtains the configuration information of the configuration items after the user completes input into the input boxes of the configuration items.

In S102, a detail page of the target service package is generated according to the configuration information of the configuration items of the target service package, and an access address of the detail page of the target service package is determined.

In some embodiments, after obtaining the configuration information of configuration items of the target service package, the management server generates the detail page of the target service package according to the configuration information of the configuration items of the target service package.

The management server may fill the configuration information of configuration items of the target service package into a preset template of the detail page of the target service package, so as to obtain a first draft of the detail page of the target service package. Then, according to the language to be used in the detail page of the target service package, the first draft of the detail page of the target service package is converted to obtain the detail page of the target service package.

In some embodiments, the detail page of the target service package is a fifth-generation hypertext markup language (H5) page. Hypertext markup language is an application under the standard universal markup language. “Hypertext” means that the page can contain pictures, links, and even music, programs, and other non-text elements. The structure of the hypertext markup language includes a “head” and a “body”. The “head” provides information about the web page, and the “body” provides the specific content of the web page.

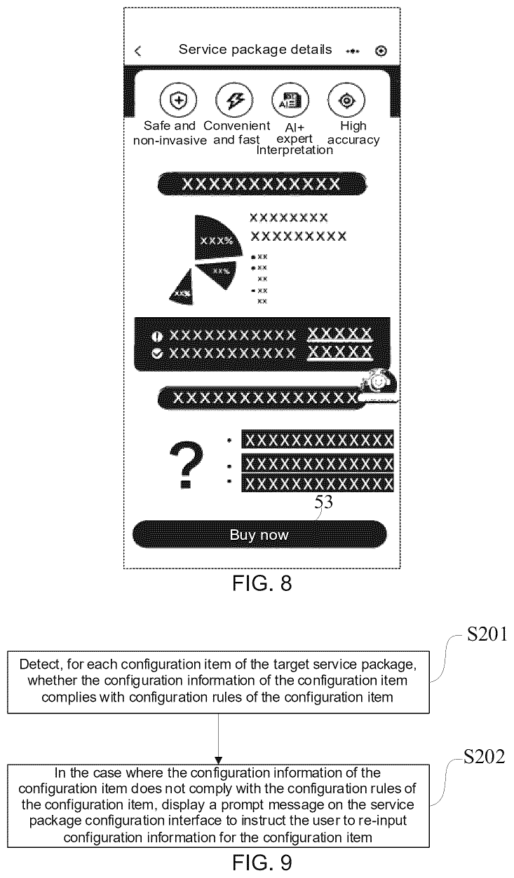

For example, in the case where the detail page of the target service package is the H5 page, the detail page of the target service package is as shown in FIG. 8. Introduction information of the target service package can be displayed on the detail page of the target service package, and the user can learn more details about the target service package by sliding down on the screen of the terminal device.

In some embodiments, while the management server generates the detail page of the target service package according to the configuration information of the configuration items of the target service package, the management server can also generate the access address belonging to the detail page of the target service package, for the detail page of the target service package. The access address of the detail page of a target service package is used to uniquely indicate the detail page of the target service package, so that the terminal device may accurately access the detail page of the target service package according to the access address of the detail page of the target service package.

In S103, information for instructing the target service package to be launched is sent to the target mini program associated with the target service package.

It should be understood that, when the management server generates the detail page of the target service package according to the configuration information of configuration items of the target service package, it means that the target service package has been developed and can be launched in the target mini program associated with the target service package, thereby increasing the scope of services provided by the target mini program.

In some embodiments, preset corresponding relationships between a plurality of service packages and a plurality of mini programs are stored in the memory of the management server in advance. One mini program may have corresponding relationships with multiple service packages. After the management server generates the detail page of the target service package and determines the access address of the detail page of the target service package, the management server may determine the target mini program corresponding to the target service package according to the preset corresponding relationships.

Optionally, after the management server generates the detail page of the target service package and determines the access address of the detail page of the target service package, the management server may send a prompt message for prompting the user to input the target mini program associated with the target service package. Furthermore, after receiving the information input by the user, the management server may analyze the information input by the user to determine the target mini program associated with the target service package.

Further, after the management server determines the target mini program associated with the target service package, the management server may send information, used for instructing the target service package to be launched, to the target mini program associated with the target service package. The information for instructing the target service package to be launched includes the access address of the detail page of the target service package.

In this way, when the user views the target service package in the target mini program through the terminal device, the terminal device may access the detail page of the target service package according to the access address of the detail page of the target service package for the user to view.

Based on the embodiments shown in FIG. 3, at least the following beneficial effects are brought about. After obtaining the configuration information of the configuration items of the target service package input by the user, the management server generates the detail page of the target service package according to the configuration information of the configuration items of the target service package, thereby completing the development of the target service package. In this way, in the method for configuring the service package provided in the embodiments of the present disclosure, it only requires the user to input the configuration information of the configuration items of the target service package, thereby completing the development and launch of the target service package, without manual development based on code by developers. Thus, the development efficiency of the service package of the mini program is improved, the development cycle of the service package of the mini program is shortened, and the workload of developers is reduced.

The above embodiments focus on the configuration process of the target service package and the launch process of the target service package. In some embodiments, in the configuration process of the target service package, the method for configuring the service package provided in the embodiments of the present disclosure further involves an approval process for the configuration information of the configuration items of the target service package, and as shown in FIG. 9, the method further includes the following steps S201 and S202.

In S201, for each configuration item of the target service package, whether the configuration information of the configuration item complies with configuration rules of the configuration item is detected.

It can be understood that, each configuration item of the target service package needs to be displayed on the mini program interface. In order to ensure the rationality of the display of each configuration item of the target service package on the mini program interface, when the management server obtains the configuration information of the configuration item of the target service package input by the user, the management server detects, for each configuration item of the target service package, whether the configuration information of the configuration item complies with the configuration rules of the configuration item.

For example, in combination with the service package configuration interface shown in FIG. 7, it is assumed that a configuration item is the service package name, the configuration rules of the configuration item may include the following situations.

In Scenario 1, it is determined whether the service package name obtained this time has already existed.

It can be understood that, if it is detected that the service package name obtained this time has already existed, it means that a user has already used this service package name before this time. Since different service packages may correspond to different medical expert teams for providing services, the service package name needs to be unique. Therefore, it is necessary to determine whether the service package name obtained this time has already existed.

In Scenario 2, it is determined whether the number of words of the service package name obtained this time is greater than or equal to the preset number of words.

It can be understood that, the service package name is used to introduce the services that the service package can provide to a certain extent. Therefore, the number of words of the service package name needs to be limited. As a result, patients may quickly match target service packages with their own conditions according to service package names.

The preset number of words may be stored in the memory of the management server in advance by the developer. For example, the preset number of words is 5.

In Scenario 3, it is determined whether there are space(s) or other unknown character(s) in the service package name obtained this time.

It can be understood that, if there are space(s) and other unknown character(s) in the service package name, the service package name may not be displayed properly on the mini program interface. In order to ensure that the normal display of each service package name on the mini program interface, it is necessary to ensure three are no space(s) and other unknown character(s) in the service package name.

As shown in FIG. 7, it is assumed that a configuration item is the picture, the configuration rules of the configuration item may include determining whether the size of the obtained picture meets the preset size and whether the resolution of the picture meets the preset resolution.

It can be understood that, if the size of the obtained picture does not meet the preset size or the resolution of the obtained picture does not meet the preset resolution, the picture may not be displayed properly on the mini program interface. In order to ensure the normal display of the picture on the mini program interface, it is necessary to ensure that the size of the picture meets the preset size and the resolution of the picture meets the preset resolution.

Both the preset size and the preset resolution may be stored in the memory of the management server in advance by the developer. For example, the preset size is 2 inches and the preset resolution is 350 dpi.

In some embodiments, the configuration items of the target service package may have a unified configuration rule, and the unified configuration rule may be to determine whether the input box of each configuration item is empty.

It can be understood that, if the input box of a certain configuration item of the target service package is empty, it means that the user may have missed the input of the configuration information for the configuration item. In order to ensure the integrity of the configuration information of each configuration item of the target service package, it is necessary to ensure that the input box of each configuration item of the target service package is not empty.

In S202, in the case where the configuration information of the configuration item does not comply with the configuration rules of the configuration item, a prompt message is displayed on the service package configuration interface to instruct the user to re-input configuration information for the configuration item.

Optionally, it is assumed that a configuration item is the service package name, if it is detected that the service package name obtained this time has already existed, the management server displays a first prompt message on the service package configuration interface to instruct the user to re-input a service package name.

For example, the content of the first prompt message may be “The service package name has already existed, please re-input it!”.

Optionally, it is assumed that a configuration item is the picture, if it is detected that the size of the picture obtained this time does not meet the preset size or the resolution of the picture obtained this time does not meet the preset resolution, the management server displays a second prompt message on the service package configuration interface to instruct the user to re-upload a picture.

For example, the content of the second prompt message may be “Please re-upload a picture, and ensure that the size of the picture is 2 inches and the picture resolution is above 350 dpi”.

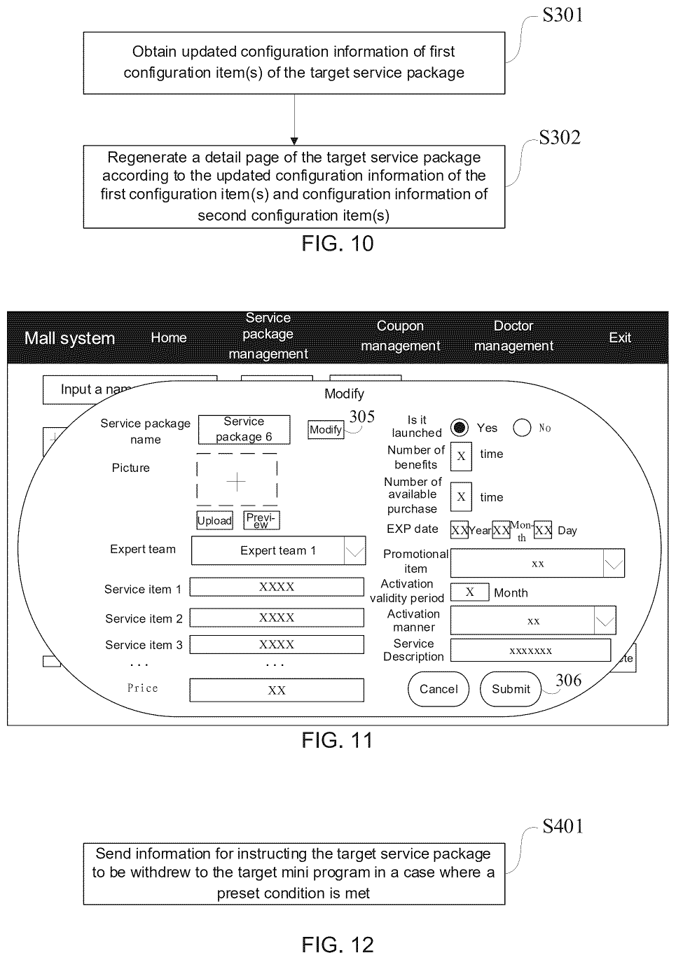

The above embodiments focus on the configuration process of the target service package and the launch process of the target service package. In some embodiments, after the configuration of the configuration items of the target service package is completed, the method for configuring the service package provided in the embodiments of the present disclosure further involves a modification process for the configuration items of the target service package that have already been configured, and as shown in FIG. 10, the method further includes the following steps S301 and S302.

In S301, updated configuration information of first configuration item(s) of the target service package is obtained.

In some embodiments, after the target service package is launched, if the user needs to change a certain configuration item of the target service package, the user can change the first configuration item of the target service package through the service package configuration interface. The first configuration item of the target service package is any configuration item in the plurality of configuration items of the target service package.

As shown in FIG. 6, it is assumed that Service package 1 is the target service package, that is, the user needs to change a certain configuration item of Service package 1. Then, the user can operate the icon of the function button of “Modify” 304 corresponding to Service package 1 shown in FIG. 6 to enter a service package modification interface. After receiving the user's operation instruction for the icon of the function button of “Modify” 304 corresponding to Service package 1, the management server displays the service package modification interface.

For example, the service package modification interface is as shown in FIG. 11. For example, if the user needs to modify the service package name, the service package name is the first configuration item. If the user needs to modify the service package name and picture, the service package name and picture are the first configuration items.

For example, it is assumed that the user needs to modify the service package name, the user can operate the icon of the function button of “Modify” 305 after the input box of the service package name to clear the content in the input box of the service package name, so that the user can re-input a service package name in the input box of the service package name.

After receiving the user's operation instruction for the icon of the function button of “Modify” 305 after the input box of the service package name, the management server clears the content in the input box of the service package name in response to the operation instruction.

After the management server clears the content in the input box of the service package name, the user can re-input a service package name in the input box of the service package name. And after the user re-inputs the service package name in the input box of the service package name, the user can operate the icon of the function button of “Submit” 306 shown in FIG. 11 to submit the updated service package name, i.e., submit the configuration information of the updated first configuration item.

For example, the service package name re-input by the user is Service package 7.

It should be noted that, after the user updates the first configuration item of the target service package, a configuration device of the server needs to detect the updated configuration information of the first configuration item to detect whether the updated configuration information of the first configuration item complies with to the configuration rules for the configuration item.

After receiving the user's operation instruction for the icon of the function button of “Submit” 306, the management server obtains the updated configuration information of the first configuration item of the target service package in response the operation instruction.

In S302, a detail page of the target service package is regenerated according to the updated configuration information of the first configuration item(s) and configuration information of second configuration item(s).

The second configuration item(s) are configuration item(s) other than the first configuration item(s) in the configuration items of the target service package. In combination with the service package modification interface shown in FIG. 11, the second configuration items may be all configuration items except for the configuration item of the service package name.

In some embodiments, the access address of the detail page of the target service package after regeneration is the same as the access address of the detail page of the target service package before regeneration. In this way, it is ensured that the user may still use the original access address to access the detail page of the target service package.

The above embodiments focus on the launching process of the target service package. In some embodiments, after the target service package is launched, the method for configuring the service package provided in the embodiments of the present disclosure further involves a withdrawing process of the target service package, and as shown in FIG. 12, the method further includes the following step S401.

In S401, information for instructing the target service package to be withdrew is sent to the target mini program in a case where a preset condition is met.

The preset withdrawing condition includes any of the following.

### (1) The Launch Duration of the Target Service Package Reaching the Preset Duration

The preset duration of the target service package is the validity period of the target service package. It can be understood that, under a promotional activity, the user can set the price of the target service package relatively low, but the low price of the target service package should be maintained within a certain time range. When the cycle of the promotional activity ends (that is, after the launch duration of the target service package reaches the preset duration), the target service package needs to be withdrew. In this case, the management server may automatically send the message for instructing the target service package to be withdrew to the target mini program.

### (2) The Inventory Number of Target Service Packages Being Less Than or Equal to the Preset Number

It can be seen from the above description of the inventory of the target service packages that the preset number of target service packages is the number of available purchase of the target service packages, i.e., the number of times the medical expert team of the target service packages can provide medical services within the current cycle. When the inventory number of target service packages is less than or equal to the preset number, which means that the medical expert team of the target service packages is no longer able to provide more medical services within the current cycle. In this case, the management server may automatically send the message for instructing the target service package to be withdrew to the target mini program.

(3) Receiving the Operation Instruction for Instructing the Target Service Package to be Withdrew from the User

In some embodiments, when the user needs to withdraw the target service package, the user can operate the icon of the function button of “Modify” corresponding to the target service package through the service package management interface to enter the service package modification interface.

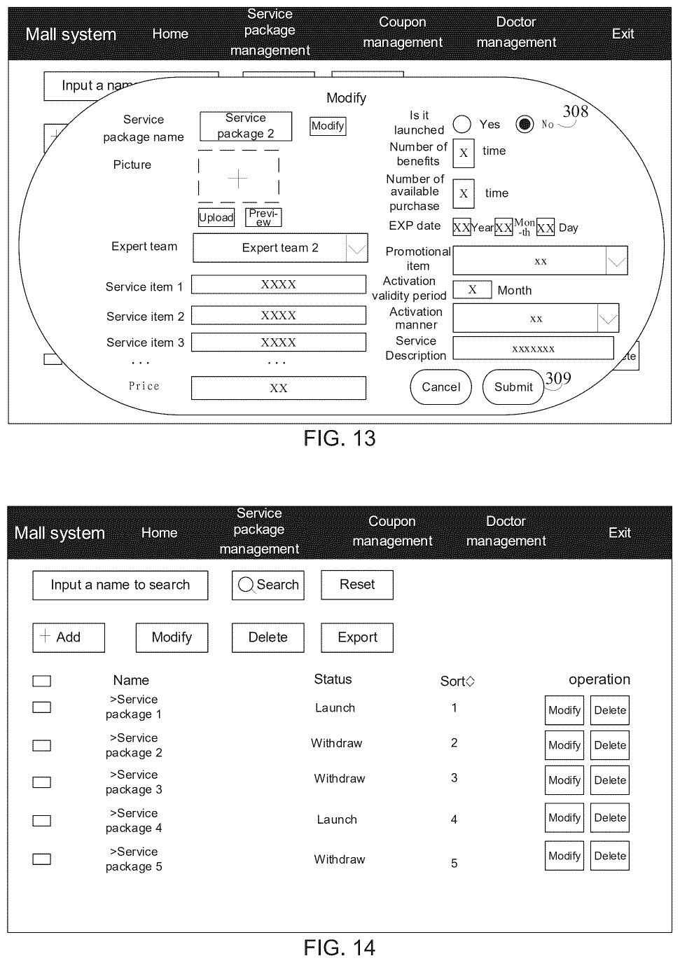

For example, as shown in FIG. 6, it is assumed that the target service package is Service package 2, the user can operate the icon of the function button of “Modify” 307 corresponding to Service package 2 to enter the modification interface of Service package 2. After receiving the user's operation instruction for the icon of the function button of “Modify” 307 corresponding to Service package 2, the management server displays the modification interface of Service package 2 in response to the operation instruction. For example, the modification interface of Service package 2 is as shown in FIG. 13. When the user chooses to withdraw the target service package, the user can change the status of “Is the target service package launched” from “Yes” to “No” by touching the icon of the function button of “No” 308 in the selection buttons of “Is it launched”. After the user changes the status of “Is the target service package launched” from “Yes” to “No”, the user can operate the icon of the function button of “Submit” 309 in FIG. 13, completing the operation instruction instructing the target service package to be withdrew. After the control device of the server receives the user's operation instruction for the icon of function button of “Submit” 309 in FIG. 13, the management server sends the information for instructing the target service package to be withdrew to the target mini program in response to the operation instruction.

In some embodiments, while the management server sends the information for instructing the target service package to be withdrew to the target mini program, the management server updates the service package management interface. The updated service package management interface may be shown in FIG. 14. As can be seen from FIG. 14, the status of Service package 2 is updated from “Launch” to “Withdraw”.

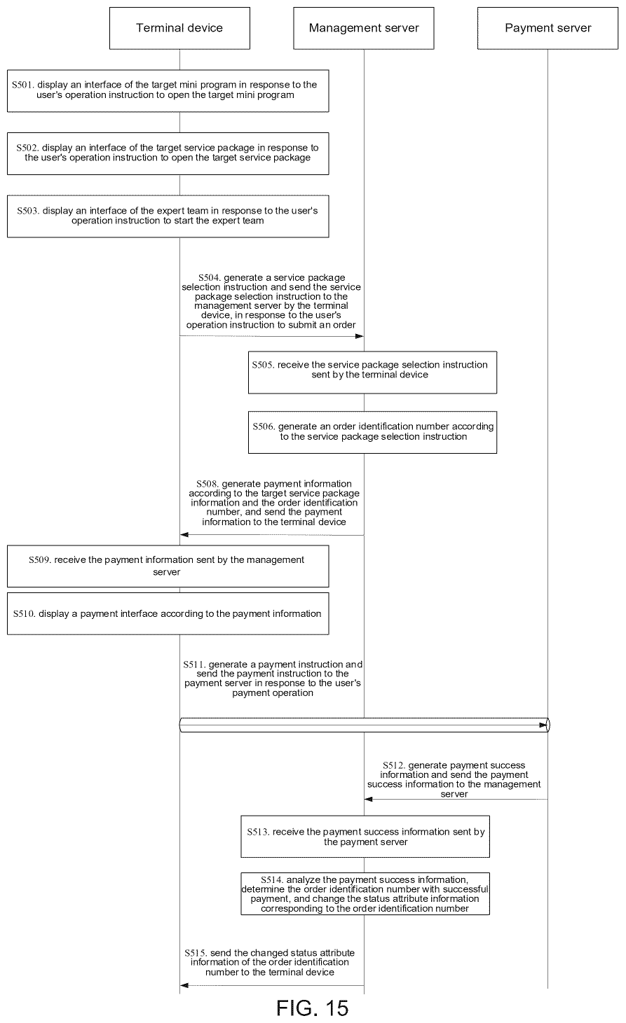

The above embodiments focus on the launching and withdrawing processes of the target service package. In some embodiments, after the target service package is launched in the target mini program, the method for configuring the service package provided in the embodiments of the present disclosure further includes a method of using the service package. As shown in FIG. 15, the method further includes the following steps S501 to S515.

In S501, the terminal device displays an interface of the target mini program in response to the user's operation instruction to open the target mini program.

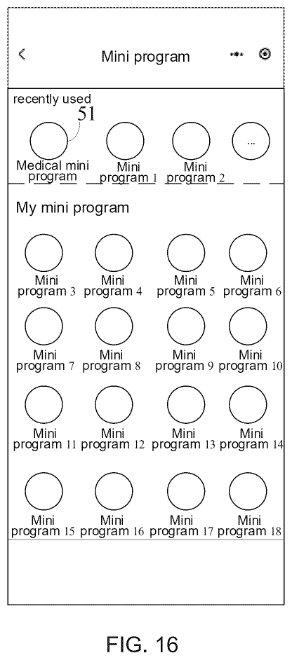

In some embodiments, when the user needs to use the target mini program, the user can slide down the screen on the interface of the instant messaging application of the terminal device to enter the mini program display interface. After receiving the user's slide instruction on the interface of the instant messaging application, the terminal device displays the mini program display interface in response to the slide instruction. For example, the mini program display interface is as shown in FIG. 16. The mini program display interface displays a plurality of mini programs that the user has recently used and a plurality of mini programs that the user has followed.

On the mini program display interface, the user can operate the icon of the target mini program to enter the target mini program. After receiving the user's operation instruction for the icon of the target mini program, the terminal device displays the interface of the target mini program in response to the operation instruction.

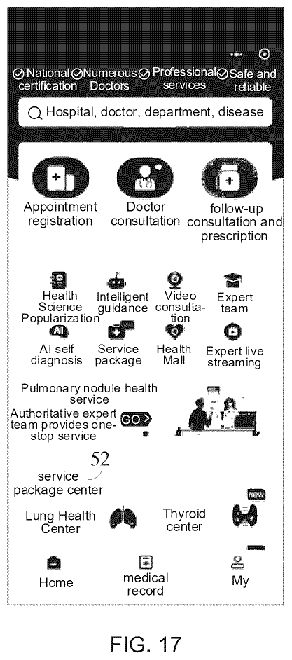

For example, the target mini program is a medical mini program 51, the user can touch the icon of the medical mini program 51 to enter a main interface of the medical mini program 51. For example, the main interface of the medical mini program 51 is as shown in FIG. 17. The main interface of the medical mini program 51 displays a search box for users to search for hospital, doctor, department or disease. The interface of the medical mini program 51 further displays icons of function buttons such as appointment registration, doctor consultation, and follow-up consultation and prescription. The users can operate the icon of a corresponding function button according to their own needs to present a corresponding function interface.

As shown in FIG. 17, the interface of the medical mini program 51 further displays navigation interface of service package center. For example, the service package center includes a lung health center and a thyroid center. The users can operate the icon of a corresponding service package center according to their own needs to enter an interface of the corresponding service package center.

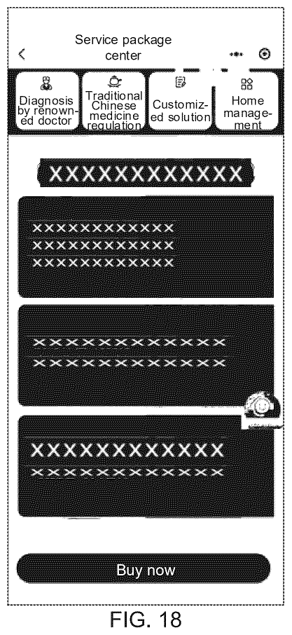

In some embodiments, if the user does not find the service package of interest on the main interface of the medical mini program 51, the user can operate the icon of “Service package center” 52 to enter an interface of Service package center” 52. After receiving the user's operation instruction for the icon of Service package center” 52, the terminal device displays the interface of the service package center in response to the operation instruction. For example, the interface of the service package center is as shown in FIG. 18. The interface of the service package center may include brief introduction pages of the plurality of service packages. The users can search for a target service package that suits their physical conditions based on the brief introduction pages of the plurality of service packages displayed on the interface of the service package center.

In S502, the terminal device displays an interface of the target service package in response to the user's operation instruction to open the target service package.

After the user determines the target service package on the interface of the service package center, the user can operate on the brief introduction page of the target service package to enter the interface of the target service package. After the terminal device receives the user's operation instruction for the brief introduction page of the target service package, the terminal device displays the interface of the target service package in response to the instruction. For example, the interface of the target service package is as shown in FIG. 8. The interface of the target service package may also be called a detail page of the target service package. The detail page of the target service package may display the detailed introduction to the services that the target service package can provide, treatment success rate analysis table, and introduction page of the expert team providing treatment services. Therefore, users can determine whether to purchase this target service package based on the introduction on the detail page of the target service package and their own physical conditions.

In S503, the terminal device displays an interface of the expert team in response to the user's operation instruction to start the expert team.

It can be understood that, if the users need to purchase a target service package, it is more important to understand the expert team of the target service package that provides medical services, so as to understand whether the field(s) in which the expert team of the target service package is expert are consistent with their own physical conditions. Based on this, the user can operate the introduction page of the expert team on the interface of the target service package to enter the interface of the expert team. After the terminal device receives the user's operation instruction for the introduction page of the expert team, the terminal device displays the interface of the expert team in response to the operation instruction.

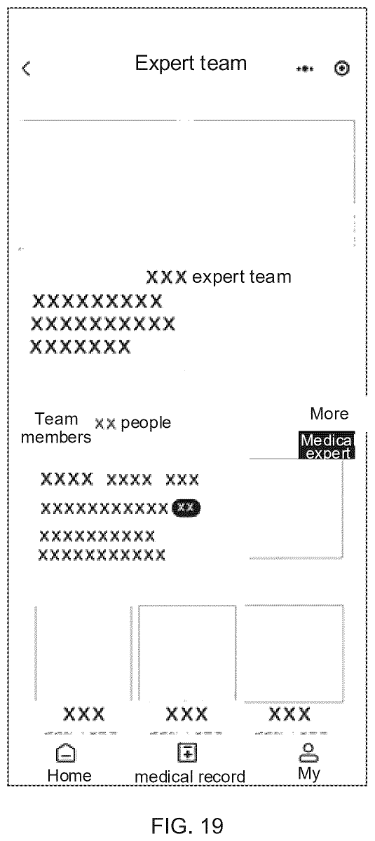

For example, the interface of the expert team is as shown in FIG. 19. The interface of the expert team displays detailed introduction to the medical field(s) that the expert team is expert in, as well as profile page of each doctor who constitutes the expert team. The profile page of a doctor includes position, length of service, and education of the doctor, as well as medical field(s) the doctor is expert in.

In S504, the terminal device generates a service package selection instruction and sends the service package selection instruction to the management server, in response to the user's operation instruction to submit an order.

In some embodiments, after the user determines to purchase the target service package after browsing the interface of the target service package and the interface of the expert team of the target service package, as shown in FIG. 8, the user can operate the icon of the function button of “Buy now” 53 shown in FIG. 8 to enter the payment interface. After receiving the user's operation instruction for the icon of the function button of “Buy now” 53, the terminal device enters the payment interface in response to the operation instruction.

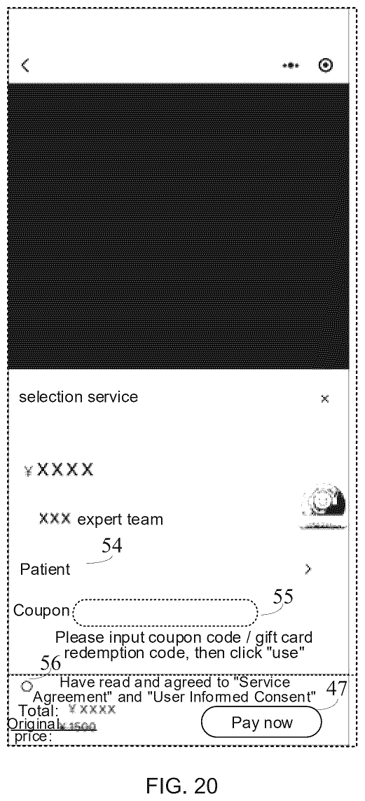

For example, the payment interface is as shown in FIG. 20. The payment interface may display a name of the target service package, a name of the expert team, a patient selection item 54, an input box 55 for a coupon, a price display column, etc.

In some embodiments, the user can operate the patient selection item 54 to determine the patient. After receiving the user's operation instruction for the patient selection item 54, the terminal device determines the patient of the target service package in response to the operation instruction.

In some embodiments, if the user has a coupon or gift card, the user can input the coupon code or gift card redemption code in the input box 55 for the coupon to complete the entry of the discount information. After receiving the user's input operation on the input box 55 for the coupon, the terminal device verifies the coupon code or gift card redemption code input by the user in response to the operation instruction.

Optionally, if the terminal device verifies that the coupon code or gift card redemption code input by the user is correct, the terminal device controls the price displayed in the price display column minus the corresponding amount of the coupon or gift card.

Optionally, if the terminal device verifies that the coupon code or gift card redemption code input by the user is incorrect, the terminal device displays a prompt message for prompting the user to re-input a coupon code or gift card redemption code.

In some embodiments, if the user does not have a coupon or gift card, the input box 55 for the coupon may be empty.

In some embodiments, after the user completes the determination of the patient and the entry of the coupon, the user can choose to view “Service Agreement” and “User Informed Consent”. And after the review is completed, the user operates the selection button 56 before “Service Agreement” and “User Informed Consent” to confirm the completion of viewing “Service Agreement” and “User Informed Consent”. After receiving the user's operation on the selection button 56, the terminal device determines that the user has viewed “Service Agreement” and “User Informed Consent”, and grants the user permission to complete the payment, in response to the operation instruction.

In some embodiments, after operating the selection button 56, the user can operate the button of “Pay now” 47 to submit the order. After receiving the user's operation on the button of “Pay now” 47, the terminal device generates a service package selection instruction and sends the service package selection instruction to the management server, in response to the operation instruction.

In some embodiments, the service package selection instruction includes target service package information, time information, terminal device identification code, and patient identification.

The target service package information includes the identification of the target service package, the price of the target service package, etc. The identification of the target service package is used to uniquely indicate a target service package. For example, the identification of the target service package may be the name of the target service package. The price of the target service package may be the price after discounting with the coupon. The time information is used to indicate the time the user submitted the order. The terminal device identification code is used to uniquely indicate a terminal device. For example, the terminal device identification code may be the international mobile equipment identity (IMEI) of the terminal device. The patient identification is used to uniquely indicate a patient. For example, the patient identification may be a patient name.

In S505, the management server receives the service package selection instruction sent by the terminal device.

In S506, the management server generates an order identification number according to the service package selection instruction.

In some embodiments, after the management server receives the service package selection instruction sent by the terminal device, the management server analyzes the service package selection instruction and obtains the target service package information, time information, terminal device identification code, and patient name contained in the service package selection instruction, and generate the order identification number according to the time information, terminal device identification code and patient name. The order identification number is used to uniquely indicate an order.

Since the time information and the terminal device identification code are unique, the generated order identification number is unique and will not be repeated with other orders. Thus, the management server can quickly search and manage the order.

For example, the time information obtained by analysis is Jan. 1, 2022, the terminal device identification code is 123456789101112, the patient identification is 66688, and the generated order identification number is 20221112345678910111266688.

In S507, the management server stores the order identification number in an order management list.

There are a plurality of order identification numbers and status attribute information corresponding to each order identification number stored in the order management list. The status attribute information includes paid status or unpaid status.

In S508, the management server generates payment information according to the target service package information and the order identification number, and sends the payment information to the terminal device.

As can be seen from the above description of the target service package information that the target service package information includes the price of the target service package. It is assumed that the price of the target service package is 1288 yuan, the management server generates the payment information according to the price of the target service package “1288” and the order identification number “20221112345678910111266688”, and sends the payment information to the terminal device.

In S509, the terminal device receives the payment information sent by the management server.

In S510, the terminal device displays a payment interface according to the payment information.

In some embodiments, after receiving the payment information sent by the management server, the terminal device generates the payment interface according to the payment data contained in the payment information. The payment interface displays the price to be paid, order identification number and payment manners.

There may be multiple payment manners, and users can choose a corresponding payment manner according to their own conditions.

In some embodiments, after the terminal device receives the user's operation instruction of selecting the target payment manner, the terminal device establishes a connection with the payment server of the target payment manner and sends the interface address of the payment server to the management server, in response to the operation instruction.

In S511, the terminal device generates a payment instruction and sends the payment instruction to the payment server in response to the user's payment operation.

After the user completes the operation of selecting the payment manner and inputting the payment password on the payment interface, the terminal device generates the payment instruction and sends it to the corresponding payment server through the payment interface in response to the operation instruction. The payment instruction includes the payment password.

In S512, the payment server generates payment success information and sends the payment success information to the management server.

After receiving the payment instruction sent by the terminal device, the payment server verifies the payment password included in the payment instruction. When the verification is passed, the payment server generates the payment success information and sends the payment success information to the management server. The payment success information includes the order identification number.

In some embodiments, the payment information is time-sensitive. For example, the payment information is valid for 30 minutes. If the user fails to complete the payment within the valid period of the payment information, that is, the management server does not receive the payment success information sent by the payment server within 30 minutes, the management server sends order cancellation information to the terminal device to prompt the user that the order is invalid, and prompt the user to re-purchase.

Optionally, while the management server sends the order cancellation information to the terminal device, the management server deletes the order identification number corresponding to the order in the order management list, thereby improving the storage resource utilization of the management server.

In some embodiments, when the difference between the current time and the order expiration time is within a certain time range (e.g., 5 minutes), the management server generates payment prompt information and sends the payment prompt information to the terminal device, so as to prompt the user to complete the payment, thereby avoiding invalidation of the order.

In S513, the management server receives the payment success information sent by the payment server.

In S514, the management server analyzes the payment success information, determines the order identification number with successful payment, and changes the status attribute information corresponding to the order identification number.

In some embodiments, after receiving the payment success information sent by the payment server, the management server may analyze the payment success information to determine the order identification number corresponding to the payment success information. Thus, according to the order identification number, the management server changes the status attribute information of the order in the order management list from the unpaid status to the paid status.

It should be noted that the change of the status attribute information corresponding to the order identification number is based on the payment time information in the payment success information received by the management server. When the management server receives multiple pieces of payment success information with the same order identification number within a period of time, the management server extracts multiple pieces of payment time information from the multiple pieces of payment success information and determines the earliest payment time among the multiple pieces of payment time information. When the payment time information is the earliest payment time, the management server generates payment verification success information and sends the payment verification success information to the payment server, and then updates the status attribute information corresponding to the order identification number from the unpaid status to the paid status. When the payment time information is not the earliest payment time, the management server generates payment verification failure information and sends the payment verification failure information to the payment server.

For example, the user shares the payment information sent by the management server to the user group to find someone to pay on his/her behalf, and multiple users make payments at the same time. The payment server sends multiple pieces of payment success information to the management server at the same time. The management server extracts the payment time information from the multiple pieces of payment success information, and the extracted payment times are 10:25:05, 10:25:01, 10:25:53, 10:25:00 on Jan. 1, 2022. The management server determines that 10:25:00 on Jan. 1, 2022 is the earliest payment time. Based on the payment success information with the payment time of 10:25:00 on Jan. 1, 2022, the management server returns the payment verification success information to the payment server, and the management server updates the status attribute information of the order identification number corresponding to the payment time of 10:25:00 on Jan. 1, 2022 from the pending payment status to the paid status. At the same time, the management server returns the payment verification failure information to the payment server based on the payment success information with the payment times of 10:25:05 on Jan. 1, 2022, 10:25:01 on Jan. 1, 2022, and 10:25:53 on Jan. 1, 2022, and the payment server refunds the payment based on the payment verification failure information.

In some embodiments, if the management server detects that the status attribute information corresponding to the order identification number is the paid status, the management server generates the payment verification failure information and sends the payment verification failure information to the payment server. The payment verification failure information includes the order identification number.

It can be understood that, when the user uses the terminal device to make an online payment, the payment may be repeated multiple times due to poor network environment or user misoperation during the operation; when the management server detects that the status attribute information corresponding to the order identification number is the paid status, the management server generates the payment verification failure information and sends the payment verification failure information to the payment server, so that the payment server refunds the user based on the order identification number included in the payment verification failure information. Because the order identification number is unique, the payment server may accurately refund the user who has made repeated payments, thus avoiding the impact of multiple repeated payments on the user experience.

In S515, the management server sends the changed status attribute information of the order identification number to the terminal device.

After the management server changes the status attribute information corresponding to the order identification number from the unpaid status to the paid status, the management server may send the changed status attribute information of the order identification number to the terminal device to prompt the user that the payment is successful. While the payment is completed, the payment status is synchronized between the terminal device and the management server.

In some embodiments, after the terminal device prompts the user that the payment has been successful for a preset period of time (for example, 30 seconds), the terminal device may automatically display a reservation detail page.

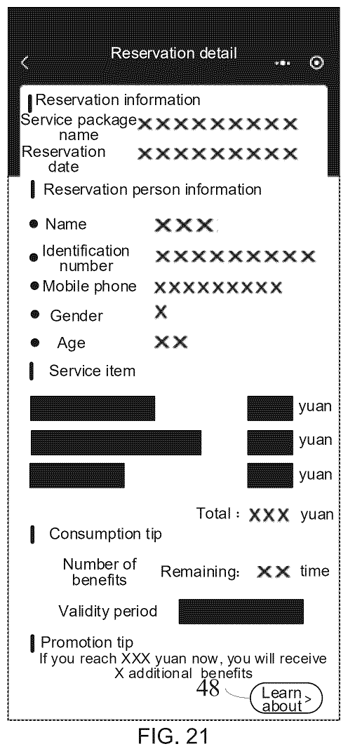

For example, the reservation detail page is as shown in FIG. 21. The reservation detail page displays reservation information, reservation person information, service item information, consumption tip and promotion tip. The reservation information includes the name of the reserved service package and the reservation date. The reservation person information includes the reservation person's name, identification number, mobile phone number, gender and age. The service item information includes the names of the service items provided by the service package, as well as the price corresponding to each service item and the total price. The consumption tip includes the number of benefits included in the purchased service package and the validity period of the service package. The promotion tip includes the current discount information provided by the medical mini program. If the user is interested in the discount information, the user can operate the button of “Learn about” 48 on the reservation detail page to present a promotion detail page. If the terminal device receives the user's operation instruction for the button of “Learn about” 48, the terminal device displays the promotion detail page in response to the operation instruction.

In some embodiments, the promotion detail page may display a variety of discount information.

In some embodiments, after the user purchases the target service package, the user can view “My Order” to present the service package list page, and then the user may choose to use the purchased target service package. When the user chooses to use the target service package, the user needs to activate the target service package.

In some embodiments, the activation manners of the target service package include manual activation and automatic activation. The manual activation requires the user to actively operate the icon of the function button of “Activate Now” corresponding to the target service package within the validity period of the target service package to trigger the activation of the target service package. After the terminal device receives the user's operation instruction for the icon of the function button of “Activate Now”, the terminal device activates the target service package in response to the operation instruction. The automatic activation means that after the user purchases the target service package, the target service package automatically enters the activation state.

When the target service package is activated, the user can use the target service package. After the terminal device receives the user's operation instruction for using the target service package, in response to the operation instruction, the terminal device displays each service item of the target service package and opens a third-party system (such as the “Zhuojian” System) to facilitate the user's consultation.

In some embodiments, after the user has used the service items of the target service package once, that is, after the user has used the benefit of the target service package once, the terminal device hosting the target mini program sends a prompt message to the management server indicating that the number of benefits has been completed once, so as to notify the management server that the order represented by the order identification number corresponding to the target service package has completed the benefit one time.

In some embodiments, after the user has used all the number of benefits of the target service package, it means that the services represented by the target service package have been completed, and the terminal device hosting the target mini program sends a prompt message to the management server indicating that the services have been completed, so as to prompt the management server that the order represented by the order identification number corresponding to the target service package has been completed. After receiving the prompt information, the management server updates the order status represented by the order identification number to completed. In this way, the usage process of the target service package is completed.

The above embodiments focus on the process of users purchasing and using service packages. In some embodiments, users can also use the medical mini program to conduct specialized consultations with doctors they are interested in.

For example, as shown in FIG. 19, the interface of the expert team displays detailed introduction to the medical fields that the expert team is expert in, as well as profile page of each doctor who constitutes the expert team. If the user determines a target doctor from a plurality of doctors based on each doctor's profile page and his or her own physical condition, the user can operate on the target doctor's profile page to enter the target doctor's detail page. The target doctor can be any one of plurality of doctors.

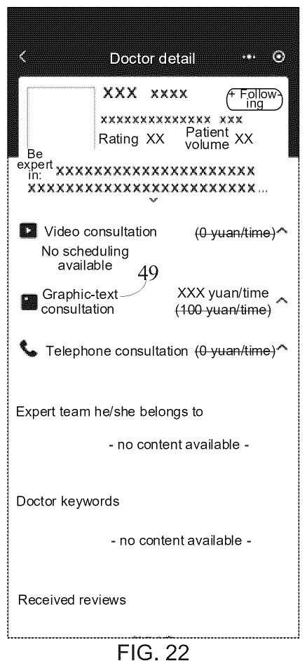

After receiving the user's operation instruction for the target doctor's profile page, the terminal device displays the target doctor's detail page in response to the operation instruction. For example, the target doctor's detail page is as shown in FIG. 22. The target doctor's detail page may include the doctor's name, position, medical experience, rating, patient volume, expert field.

In some embodiments, as shown in FIG. 22, the target doctor's detail page may include the price of the target doctor's video consultation, the price of graphic-text consultation, and the price of telephone consultation. It may further include the expert team to which the target doctor belongs, doctor keywords, and reviews received. Thus, the user learns about the target doctor based on the introduction on the target doctor's detail page, thereby improving the user's consultation experience.

In some embodiments, if the user needs to graphic-text consultation, the user can operate the option of “Graphic-text consultation” 49 in FIG. 22 to enter the detail page of the graphic-text consultation. After receiving the user's operation instruction for the option of “Graphic-text consultation” 49, the terminal device displays the detail page of the graphic-text consultation in response to the operation instruction.

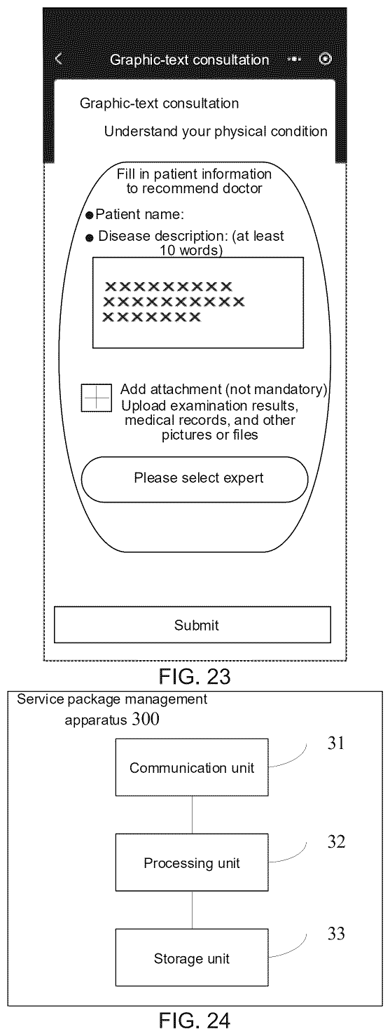

For example, the detail page of the graphic-text consultation is as shown in FIG. 23. The detail page of the graphic-text consultation displays an input box for the patient's name for the user to input the name and an input box for the condition description for the user to input the user's own patient condition. In order to improve the accuracy of the user's description for the patient condition, there is a limit on the number of words of the user inputting his or her own patient condition, for example, at least 10 words.

In some embodiments, the detail page of the graphic-text consultation further includes an add box for adding attachment, which is used to upload the user's own examination results, medical records, or pictures of the user's own patient condition in a case where the user has the user's own examination results, medical records, or pictures of the user's own patient condition. Thus, the expert can diagnose the user based on the relevant attachments and improve the efficiency and accuracy of diagnosis.

In some embodiments, the detail page of the graphic-text consultation further includes an expert selection box for the user to select the doctor he/she is interested in.

The foregoing descriptions mainly introduce the solutions provided by the embodiments of the present disclosure from perspective of method. In order to achieve the above functions, corresponding hardware structures and/or software modules for performing various functions are included. A person skilled in the art will be easy to realize that, by combining units and algorithm steps of the examples described in the embodiments disclosed herein, the embodiments of the present disclosure can be implemented in a form of hardware or a combination of hardware and computer software. Whether a certain function is performed by the hardware or a way of driving hardware by the computer software depends on a specific application and a design constraint of a technical scheme. A skilled person may use different methods for each specific application to implement the described functions, but such implementation should not be considered beyond the scope of the present disclosure.

Embodiments of the present disclosure further provide a service package management apparatus. As shown in FIG. 24, the service package management apparatus 300 may include a communication unit 31 and a processing unit 32. In some embodiments, the service package management apparatus 300 may further include a storage unit 33.

In some embodiments, the communication unit 31 is used to obtain configuration information of configuration items of a target service package.

The processing unit 32 is used to generate a detail page of the target service package according to the configuration information of the configuration items of the target service package, and determine an access address of the detail page of the target service package.

The communication unit 31 is further used to send information for instructing the target service package to be launched to the target mini program associated with the target service package. The information for instructing the target service package to be launched includes the access address of the detail page of the target service package.

In some other embodiments, the communication unit 31 is used to: display a service package configuration interface in response to an operation instruction to open the service package configuration interface, the service package configuration interface including input boxes for configuration items of the target service package; and obtain the configuration information of the configuration items of the target service package in response to the user's input operation on the input boxes for the configuration items of the target service package on the service package configuration interface.

In some other embodiments, the processing unit 32 is further used to: for each configuration item of the target service package, detect whether the configuration information of the configuration item complies with configuration rules of the configuration item; and in the case where the configuration information of the configuration item does not comply with the configuration rules of the configuration item, display a prompt message on the service package configuration interface to instruct the user to re-input the configuration information for the configuration item.

In some other embodiments, the communication unit 31 is further used to obtain updated configuration information of first configuration item(s) of the target service package.

The processing unit 32 is further used to regenerate a detail page of the target service package according to the updated configuration information of the first configuration item(s) and configuration information of second configuration item(s). The second configuration item(s) are configuration item(s) other than the first configuration item in the configuration items of the target service package. The access address of the detail page of the target service package after regeneration is the same as the access address of the detail page of the target service package before regeneration.

In some other embodiments, the communication unit 31 is further used to send information for instructing the target service package to be withdrew to the target mini program in a case where a preset withdrawing condition is met. The preset withdrawing condition includes any of the following: the launch duration of the target service package reaching the preset duration; the inventory number of target service packages being less than or equal to the preset number; receiving the operation instruction for instructing the target service package to be withdrew from the user.

In some other embodiments, the detail page of the target service package is a fifth-generation hypertext markup language (H5) page.

In some other embodiments, in the case where the target service package is the medical service package, the configuration items of the target service package include one or more of the following: service package name, medical expert team information, service package price, service item, service package picture, number of benefits, promotion, service package validity period or service package inventory information.

In some embodiments, the storage unit 33 is used to store the configuration items of the target service package.

In some other embodiments, the storage unit 33 is further used to store the preset condition.

In some other embodiments, the storage unit 33 is further used to store the updated configuration information of first configuration item(s) of the target service package.

In some other embodiments, the storage unit 33 is further used to store the access address of the detail page of the target service package.

The units in FIG. 24 may also be called modules. For example, the processing unit may be called a processing module.

If each unit in FIG. 24 is implemented in the form of a software functional module and sold or used as an independent product, it may be stored in a computer-readable storage medium. Based on this understanding, the technical solution of the embodiments of the present disclosure may essentially be embodied in the form of a software product, or part of the technical solution contributing to the existing technology or all or part of the technical solution may be embodied in the form of the software product, and the computer software product is stored in a storage medium, which includes several instructions to cause a computer device (which may be a personal computer, a service package management device, or a network device, etc.) or a processor to execute all or part of the steps of the method of each embodiment of the present disclosure. The storage medium storing the computer software product includes various types of medium capable of storing program codes, such as a USB flash disk, a mobile disk, a read-only memory (ROM), a random access memory (RAM), a magnetic disk, or an optical disk.

Some embodiments of the present disclosure provide a computer-readable storage medium (for example, a non-transitory computer-readable storage medium), the computer-readable storage medium has stored computer program instructions, and the computer program instructions, when run on a computer, cause the computer to perform the method for configuring the service package described in any of the above embodiments.

For example, the computer-readable storage medium may include, but is not limited to, a magnetic storage device (e.g., a hard disk, a floppy disk or a magnetic tape), an optical disk (e.g., a compact disk (CD), or a digital versatile disk (DVD)), a smart card and a flash memory device (e.g., an erasable programmable read-only memory (EPROM), a card, a stick or a key driver). Various computer-readable storage medium described in the embodiments of the present disclosure may represent one or more devices and/or other machine-readable storage medium for storing information. The term “machine-readable storage medium” may include, but is not limited to, wireless channels and various other medium capable of storing, containing and/or carrying instructions and/or data.

Some embodiments of the present disclosure further provide a computer program product, which is stored on, for example, a non-transitory computer-readable storage medium. The computer program product includes computer program instructions that, when executed on a computer, cause the computer to perform the method for configuring the service package described the above embodiments.

Some embodiments of the present disclosure provide a computer program. When the computer program is executed on a computer, the computer program causes the computer to perform the method for configuring the service package described in the above embodiments.

Beneficial effects of the computer-readable storage medium, the computer program product, and the computer program are same as the beneficial effects of the method for configuring the service package as described in some of the above embodiments, and details will not be repeated here.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure should be determined by the protection scope of the claims.

What is claimed is:

1. A method for configuring a service package, the method comprising:
obtaining configuration information of configuration items of a target service package;
generating a detail page of the target service package according to the configuration information of the configuration items of the target service package, and determining an access address of the detail page of the target service package; and
sending information for instructing the target service package to be launched to a target mini program associated with the target service package, the information for instructing the target service package to be launched includes the access address of the detail page of the target service package.

2. The method according to claim 1, wherein obtaining the configuration information of the configuration items of the target service package, includes:
displaying a service package configuration interface in response to an operation instruction to open the service package configuration interface, the service package configuration interface including input boxes for the configuration items of the target service package; and
obtaining the configuration information of the configuration items of the target service package in response to a user's input operation on the input boxes for the configuration items of the target service package on the service package configuration interface.

3. The method according to claim 2, further comprising:
detecting, for each configuration item of the target service package, whether configuration information of the configuration item complies with configuration rules of the configuration item; and
displaying a prompt message on the service package configuration interface in a case where the configuration information of the configuration item does not comply with the configuration rules of the configuration item, to instruct a user to re-input configuration information for the configuration item.

4. The method according to claim 1, further comprising:
obtaining updated configuration information of a first configuration item of the target service package; and
regenerating a detail page of the target service package according to the updated configuration information of the first configuration item and configuration information of a second configuration item, wherein the second configuration item is a configuration item other than the first configuration item in the configuration items of the target service package, and an access address of the detail page of the target service package after regeneration is same as the access address of the detail page of the target service package before regeneration.

5. The method according to claim 1, further comprising:
sending information for instructing the target service package to be withdrew to the target mini program in a case where a preset withdrawing condition is met, wherein
the preset withdrawing condition includes any of the following:
a launch duration of the target service package reaching a preset duration;
an inventory number of target service packages being less than or equal to a preset number; and
receiving an operation instruction for instructing the target service package to be withdrew from a user.

6. The method according to claim 1, wherein the detail page of the target service package is a fifth-generation hypertext markup language (H5) page.

7. The method according to claim 1, wherein in a case where the target service package is a medical service package, the configuration items of the target service package include one or more of the following: service package name, medical expert team information, service package price, service item, service package picture, number of benefits, promotion, service package validity period or service package inventory information.

8. (canceled)

9. A management server, wherein the management server includes a memory and a processor, wherein
the memory is coupled to the processor, and used for storing computer program codes, the computer program codes including computer instructions; and
the computer instructions, when executed by the processer, cause the processer to perform the method for configuring the service package according to claim 1.

10. A non-transitory computer-readable storage medium having stored computer program instructions that, when run on a processer, causes the processer to perform:
obtaining configuration information of configuration items of a target service package;
generating a detail page of the target service package according to the configuration information of the configuration items of the target service package, and determining an access address of the detail page of the target service package; and
sending information for instructing the target service package to be launched to a target mini program associated with the target service package, the information for instructing the target service package to be launched includes the access address of the detail page of the target service package.

11. The non-transitory computer-readable storage medium according to claim 10, wherein obtaining the configuration information of the configuration items of the target service package, includes:
displaying a service package configuration interface in response to an operation instruction to open the service package configuration interface, the service package configuration interface including input boxes for the configuration items of the target service package; and
obtaining the configuration information of the configuration items of the target service package in response to a user's input operation on the input boxes for the configuration items of the target service package on the service package configuration interface.

12. The non-transitory computer-readable storage medium according to claim 11, wherein the processer further performs:
detecting, for each configuration item of the target service package, whether configuration information of the configuration item complies with configuration rules of the configuration item; and
displaying a prompt message on the service package configuration interface in a case where the configuration information of the configuration item does not comply with the configuration rules of the configuration item, to instruct a user to re-input configuration information for the configuration item.

13. The non-transitory computer-readable storage medium according to claim 10, wherein the processer further performs:
obtaining updated configuration information of a first configuration item of the target service package; and
regenerating a detail page of the target service package according to the updated configuration information of the first configuration item and configuration information of a second configuration item, wherein the second configuration item is a configuration item other than the first configuration item in the configuration items of the target service package, and an access address of the detail page of the target service package after regeneration is same as the access address of the detail page of the target service package before regeneration.

14. The non-transitory computer-readable storage medium according to claim 10, wherein the processer further performs:
sending information for instructing the target service package to be withdrew to the target mini program in a case where a preset withdrawing condition is met, wherein
the preset withdrawing condition includes any of the following:
a launch duration of the target service package reaching a preset duration;
an inventory number of target service packages being less than or equal to a preset number; and
receiving an operation instruction for instructing the target service package to be withdrew from a user.

15. The management server according to claim 9, further comprises a communication interface used for connecting the management server to other devices through a communication network.

16. The management server according to claim 9, further comprises an output device and an input device, wherein
the output device communicates with the processor and is used for display information; and
the input device communicates with the processor and is used for receiving user input.

17. The management server according to claim 9, wherein the memory stores preset corresponding relationships between a plurality of service packages and a plurality of mini programs in advance; one mini program has corresponding relationships with service packages;
after the processor generates the detail page of the target service package and determines the access address of the detail page of the target service package, the processor determines the target mini program corresponding to the target service package according to the preset corresponding relationships.

18. The method according to claim 3, wherein the configuration rules of the configuration item include determining whether an input box of the configuration item is empty.

19. The method according to claim 3, wherein a configuration item is a service package name, and configuration rules of the service package name includes determining whether the service package name obtained this time has already existed, determining whether a number of words of the service package name obtained this time is greater than or equal to a preset number of words, and determining whether there is a space or an unknown character in the service package name obtained this time; or
a configuration item is a picture, and configuration rules of the picture includes determining whether a size of the picture meets a preset size and whether a resolution of the picture meets a preset resolution.

20. The method according to claim 6, wherein the detail page of the target service package displays introduction information of the target service package.
